(19) United States
(12) Patent Application Publication
(10) Pub. No.: US 2011/0161206 A1
(43) Pub. Date: Jun. 30, 2011

(54) SYSTEM AND METHOD FOR COLLECTION OF DATA RELATED TO THE SALE OF A VEHICLE

(75) Inventors: David J. Mateer, Torrance, CA (US); Simin Mofidi, Newport Coast, CA (US); Phil Watkins, San Pedro, CA (US); Nick Nomicos, Rancho Palo Verdes, CA (US)

(73) Assignee: Honda Motor Co., Ltd., Tokyo (JP)

(21) Appl. No.: 12/649,995

(22) Filed: Dec. 30, 2009

(51) Int. Cl. G06Q 10/00; G06K 19/00; G06Q 50/00; G06F 17/30; G06F 15/16

(52) U.S. Cl. 705/28; 235/487; 705/30; 707/802; 707/E17.044; 709/207

(57) ABSTRACT

Various exemplary embodiments relate to a method and related data collection system including one or more of the following: receiving, at the data collection system, a first message from a DMS (Dealer Management System), the first message including a Vehicle Identification Number (VIN) for the vehicle; determining a set of description data describing the vehicle using the VIN; constructing a second message including the VIN and the set of description data; transmitting the second message to the DMS; receiving, at the data collection system, a third message from the DMS, the third message including the set of description data and a set of sale information but not including the VIN; and transmitting the set of description data and the set of sale information for storage in a database.

### TECHNICAL FIELD

Various exemplary embodiments disclosed herein relate generally to data collection.

### BACKGROUND

After completing an automobile sale, a dealership may be required by a vehicle manufacturer to submit a Retail Delivery Registration (RDR). An RDR may be used by the manufacturer to determine the time period for which a warranty on the vehicle is active and typically contains the vehicle identification number (VIN) and customer-identifying information, such as a name and address. In addition to the information carried by an RDR, a dealership usually has access to additional information related to the sale of a vehicle, such as specific financing and/or leasing information. While this information might be valuable to a manufacturer when evaluating the market for its models, legal restrictions might make the transmission of this information along with the RDR difficult.

In the United States, the Gramm-Leach-Bliley Act (“GLBA”), also called the Financial Services Modernization Act of 1999, mandates that when information related to financing and/or leasing is to be disclosed along with personal identifying information, a financial institution, which may include many automobile dealers, must provide a customer with an opt-out notice and a reasonable opportunity to opt out of the disclosure. Any RDR must be able to identify, typically by VIN, the specific vehicle that has been sold. Because each VIN is unique and identifies one automobile, any RDR carrying a VIN, may easily be traced to the associated vehicle's owner. Thus, the GLBA might be read to require that, when specific financing and leasing information is to be communicated along with an RDR, the customer must be given a reasonable time to opt-out. Similar requirements or restrictions on transferring information about consumers might exist in other jurisdictions. As examples, privacy requirements may vary from state to state within the United States, from country to country, or region to region (e.g., the European Union might have privacy regulations that differ from federal laws in the United States).

### SUMMARY

Legal privacy requirements might hinder a goal of information collection. The accuracy of a market analysis performed by a manufacturer might be dependent on the completeness of the manufacturer's sales records. For example, for the GLBA, providing the customer with the option to withhold any of information from the manufacturer might lead to gaps in the data collected by the manufacturer and, ultimately, an incomplete market analysis. A consequence of this delayed reporting might be that any market analysis is performed on old data and is thus outdated.

In view of the foregoing, gathering of financing and leasing information about a vehicle sale while remaining compliant with regulations such as the Gramm-Leach-Bliley Act might be desirable. More specifically, gathering financing and leasing information for all vehicle transactions in real time without the concurrent disclosure of personal identifying information might be desirable.

A brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method and related data collection system including one or more of the following: receiving, at the data collection system, a first message from the DMS (Dealer Management System), the first message including a Vehicle Identification Number (VIN) for the vehicle; determining a set of description data describing the vehicle using the VIN; constructing a second message including the VIN and the set of description data; transmitting the second message to the DMS; receiving, at the data collection system, a third message from the DMS, the third message including the set of description data and a set of sale information but not including the VIN; and transmitting the set of description data and the set of sale information for storage in a database.

It should be apparent that, in this manner, various exemplary embodiments enable the collection of detailed sales data, including financing and leasing information, without the collection of information that may identify the owner. In particular, by receiving detailed sales information associated with a vehicle description provided to the DMS rather than a VIN, a manufacturer may collect sales information in real-time for every vehicle sold, which might ensure compliance with the privacy laws, regulations, or rules, such as the Gramm-Leach-Bliley Act.

### BRIEF DESCRIPTION OF THE DRAWINGS

In order to facilitate better understanding of various exemplary embodiments, reference is made to the accompanying drawings, wherein:

FIG. 1 is a schematic diagram of an exemplary network for collecting data related to the sale of a vehicle;

FIG. 2 is a schematic diagram of an exemplary data collection system for collecting data related to the sale of a vehicle;

FIG. 3 is a schematic diagram of an exemplary message transfer for collecting data related to the sale of a vehicle;

FIG. 4 is a flowchart of an exemplary method for collecting data related to the sale of a vehicle;

FIG. 5 is a schematic diagram of an exemplary message transfer for collecting data related to the sale of a specific vehicle; and

FIG. 6 is a schematic diagram of an exemplary report generated using collected data.

### DETAILED DESCRIPTION

Referring now to the drawings, in which like numerals refer to like components or steps, there are disclosed broad aspects of various exemplary embodiments.

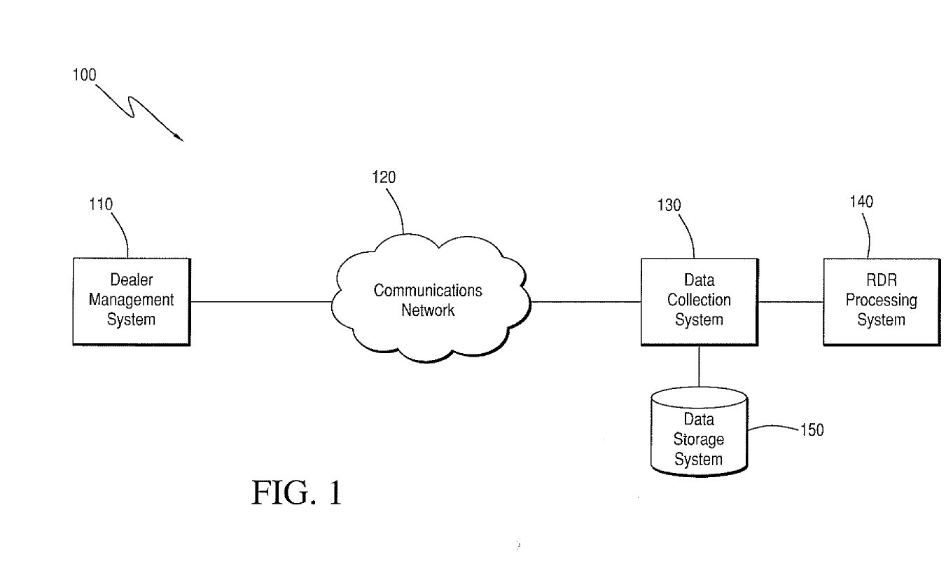

FIG. 1 is a schematic diagram of an exemplary network 100 for collecting data related to the sale of a vehicle. Exemplary network 100 may include a dealer management system (DMS) 110, a communications network 120, a data collection system 130, a retail delivery registration (RDR) processing system 140, and data storage system 150.

DMS 110 may be a system, or another type of device, that communicates with data collection system 130. DMS 110 may, for example, transmit an RDR to data collection system 130 upon the sale of a vehicle. DMS 110 may be implemented in hardware and/or executable instructions on a machine-readable storage medium. As examples, DMS 110 a personal or laptop computer, a server, a system of multiple computers, or any other device running a software tool and capable of sending data to another network device. For example, DMS 110 may be a central server which stores data, allowing multi-user access for one or more client computers that access applications of the DMS 110. DMS 110 may perform additional functions such as, for example, tracking a vehicle inventory or scheduling service appointments.

Communications network 120 may be any network, such as the Internet, for providing data communications between DMS 110 and data collection system 130. Communications network 120 may be packet-switched or circuit-switched. Further, communications network 120 may provide, for example, phone and Internet service to various user devices in communication with communications network 120.

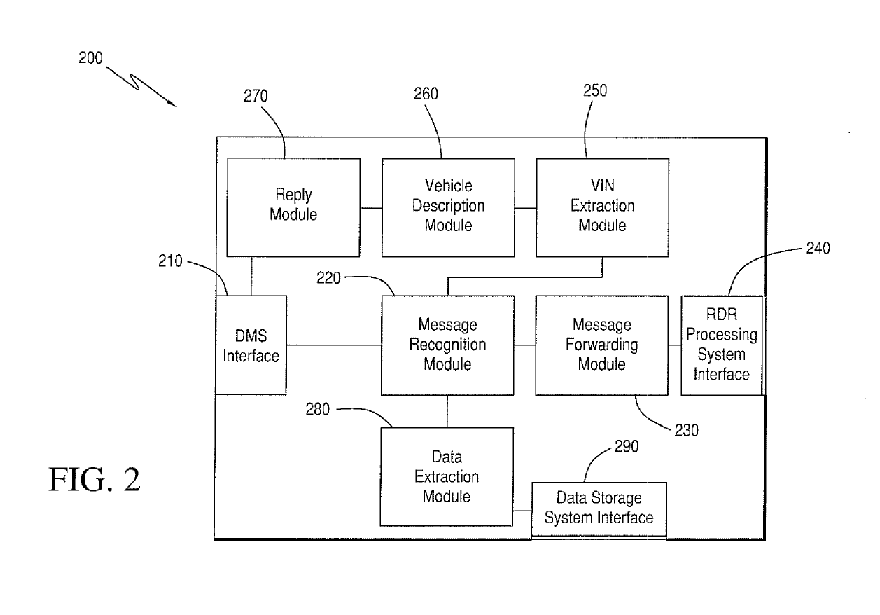

Data collection system 130 may be a system, or another type of device, that collects data for use in market analysis and other reporting. Data collection system 130 may, for example, receive an RDR from DMS 110 and forward it to RDR processing system 140. Data collection system 130 may then communicate further with DMS 110 to gain access to non-personalized sale information and subsequently send the sale information to data storage system 150. In various embodiments, data collection system 130 may be additionally adapted to receive and process types of messages other than those containing an RDR and/or non-personalized sale information. Data collection system 130 may be implemented in hardware and/or executable instructions on a machine-readable storage medium. More specifically, in various exemplary embodiments, data collection system 130 is a personal or laptop computer, a server, a system of multiple computers, or any other device capable of communicating with DMS 110, RDR processing system 140, and data storage system 150. Exemplary components for inclusion in data collection system 130 are described in further detail below with reference to FIG. 2.

RDR processing system 140 may be a system, or another type of device, that receives and processes an RDR according to the techniques and methods known in the art. RDR processing system 140 may, for example, receive an RDR from data collection system 130 and update a database (not shown) to reflect the fact that the particular vehicle has been sold and that the manufacturer's warranty is currently active. RDR processing system 140 may be implemented in hardware and/or executable instructions on a machine-readable storage medium. More specifically, in various exemplary embodiments, RDR processing system 140 is a personal or laptop computer, a server, a system of multiple computers, or any other device capable of receiving and processing an RDR. For example, RDR processing system 140 may be a server computer system that runs a software tool and provides RDR processing services to client applications. In various alternative embodiments, RDR processing system 140 may be integrated into data collection system 130.

Data storage system 150 may be a system, or another type of device, that receives and stores data. Data storage system 150 may, for example, receive vehicle description and detailed sales information from data collection system 130 and store the information for future retrieval and report generation. Data storage system 150 may be implemented in hardware and/or executable instructions on a machine-readable storage medium. More specifically, in various exemplary embodiments, data storage system 150 is a hard drive, a hard drive array, a personal or laptop computer, a server, a system of multiple computers, or any other device capable of storing and retrieving data. In some embodiments, data storage system 150 may be a separate system from data collection system 130, while in other embodiments, data storage system 150 may be integrated with the data collection system 130.

Having described the components of network 100, a brief summary of the operation of network 100 will be provided. It should be apparent that the following description is intended to provide an overview of the operation of network 100 and is therefore a simplification in some respects. The detailed operation of network 100 will be described in further detail below in connection with FIGS. 2-5.

According to various exemplary embodiments, DMS 110 may transmit an RDR over communications network 120 to data collection system 130 which, in turn, may pass the RDR to RDR processing system 140 for standard processing. Data collection system 130 may then use the vehicle identification number (VIN) contained in the RDR to generate a description of the vehicle that has been sold, such as, for example, an indication of the model, trim, and color. Data collection system 130 may proceed by sending a message to DMS 110 including this vehicle description and the VIN. DMS 110 may then retrieve detailed information related to the sale of the vehicle identified by the VIN, such as specific financing and/or leasing information. DMS 110 may send this sales information to the data collection system 130 along with the description data, but without the VIN or other unique, personally identifying information for the customer of the finance company. Finally, data collection system 130 may send the received data to data storage system 150 for future use.

FIG. 2 is a schematic diagram of an exemplary data collection system 200 for collecting data related to the sale of a vehicle. Data collection system 200 may be an implementation of data collection system 130. Data collection system 200 may include DMS interface 210, message recognition module 220, message forwarding module 230, RDR processing system interface 240, VIN extraction module 250, vehicle description module 260, reply module 270, data extraction module 280, and data storage system interface 290.

DMS interface 210 may be an interface comprising hardware and/or executable instructions encoded on a machine-readable storage medium configured to transmit and receive data over communications network 120. In particular, DMS interface 210 may communicate with DMS 110 over communications network 120.

Message recognition module 220 may include hardware and/or executable instructions on a machine-readable storage medium configured to determine the contents of a message received from DMS 110 via DMS interface 210 and route the message within data collection system 200 appropriately. In determining the contents of a message, message recognition module 220 may read the contents of the received message, read an identifier tag included in the message by DMS 110, or apply any other method known to those of skill in the art to determine whether a message carries an RDR, detailed sales information, or anything else.

After making a determination that the message carries an RDR, message recognition module 220 may route the message to both message forwarding module 230 and VIN extraction module 280. If the message instead carries detailed sales information, message recognition module 220 may forward the message to data extraction module 280. If the message is determined to carry neither an RDR nor detailed sales information, message extraction module 220 may discard the message or process the message according to the requirements of another system (not shown).

Message forwarding module 230 may include hardware and/or executable instructions on a machine-readable storage medium configured to receive and transmit an RDR to RDR processing system 140 via RDR processing system interface 240. Message forwarding module 230 may perform operations on the RDR such as addressing and encapsulation, or it may simply forward the message without modification.

RDR processing system interface 240 may be an interface comprising hardware and/or executable instructions encoded on a machine-readable storage medium configured to transmit an RDR to RDR processing system 140. In embodiments where data collection system 200 communicates with RDR processing system 140 over a communications network such as, for example, communications network 120, RDR processing system interface 240 and DMS interface 210 may be the same component within data collection system 200. Alternatively, in embodiments where RDR processing system 140 is integrated into data collection system 130, data collection system 130 may include an RDR processing subsystem (not shown) instead of an RDR processing system interface 240.

VIN extraction module 250 may include hardware and/or executable instructions on a machine-readable storage medium configured to receive an RDR and determine a VIN associated with the sold vehicle according to any method known to those of skill in the art. For example, VIN extraction module 250 may locate a VIN field in the RDR and extract the value from the field. VIN extraction module 250 may then pass the VIN to vehicle description module 260.

Vehicle description module 260 may include hardware and/or executable instructions on a machine-readable storage medium configured to receive a VIN from VIM extraction module 250 and determine a description of the vehicle identified by the VIN according to any method known to those of skill in the art. For example, vehicle description module 260 may decode the 17-character VIN to obtain certain description data encoded therein. Typically, a VIN contains characters which identify information about the vehicle such as, for example, the model and trim of the vehicle. Alternatively or additionally, vehicle description module may look up the VIN or a portion thereof in a database (not shown) to determine description information. The description determined by vehicle description module 260 may include a make, a model, a trim, an option, a color, a year, and/or any other information suitable to describe the vehicle without identifying the owner.

Reply module 270 may include hardware and/or executable instructions on a machine-readable storage medium configured to construct a reply message for transmission to the DMS 110. Reply module 270 may construct a message including the VIN and the description information determined by vehicle description module 260. Reply module 270 may then transmit the message to DMS 110 via DMS interface 210.

Data extraction module 280 may include hardware and/or executable instructions on a machine-readable storage medium configured to receive and process a sales data message. Data extraction module 280 may extract vehicle description data and detailed sales information from the received message according to any method known to those of skill in the art. The detailed sales information may include such data as the financing method, interest rate, monthly payment amount, trade-in vehicle information, or any other data that might be relevant to the manufacturer's report generation desires without identifying the owner of the vehicle. Once data extraction module 280 has extracted both detailed sales information and vehicle description data from a received message, it may transmit this information to data storage system 150 via data storage interface 290.

Data storage system interface 290 may be an interface comprising hardware and/or executable instructions encoded on a machine-readable storage medium configured to transmit data to data storage system 150. In embodiments where data collection system 200 communicates with data storage system 150 over a communications network such as, for example, communications network 120, data storage system interface 290 and DMS interface 210 may be the same component within data collection system 200. Alternatively, in embodiments where data storage system 150 is integrated into data collection system 130, data collection system 130 may include a data storage subsystem (not shown) instead of a data storage system interface 290.

It should be apparent that the illustrated components of data collection system 200 are exemplary and that data collection system 200 may include additional components. Furthermore, the described modules of data collection system 200 may be rearranged, such that the functions of multiple modules are merged into a single module or, alternatively, the functions of a single module are divided among multiple modules. Other suitable arrangements will be apparent to those of skill in the art.

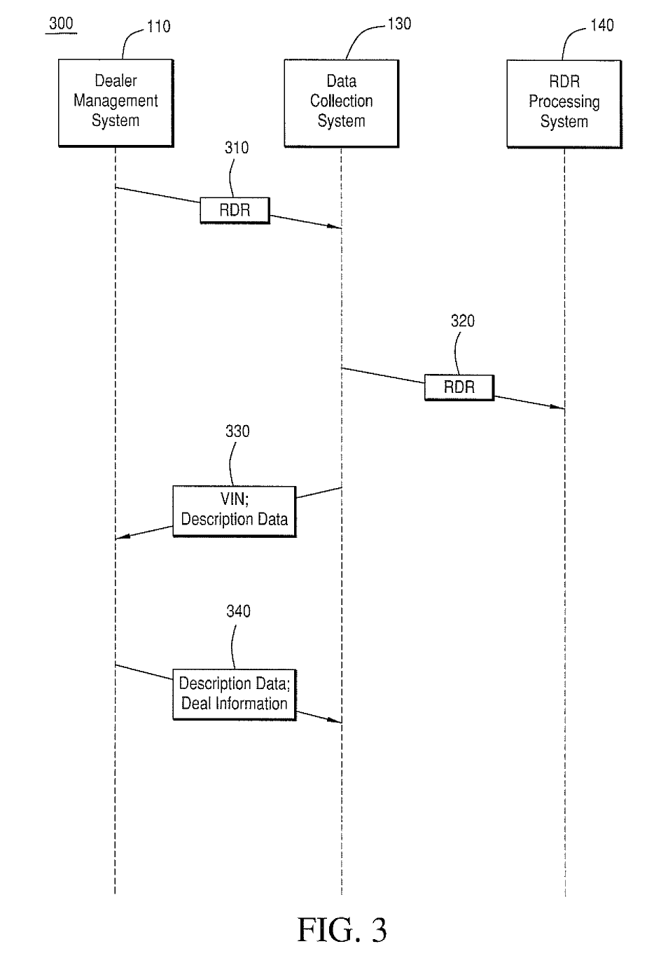

FIG. 3 is a schematic diagram of an exemplary message transfer 300 for collecting data related to the sale of a vehicle and not associated with the vehicle owner. Exemplary message transfer 300 may occur between DMS 110, data collection system 130, and RDR processing system 140. Message transfer 300 may comprise a number of individual message transmissions 310, 320, 330, 340. Each transmission 310, 320, 330, 340 may carry a payload that is a code string, an XML (eXtensible Markup Language) document, or any other appropriate format known to those of skill in the art.

Exemplary message transfer 300 may commence after the sale of a vehicle with DMS 110's transmission of an RDR 310 to data collection system 130. Data collection system 130 may immediately forward the RDR 320 to RDR processing system 140 for standard RDR processing. Data collection system 130 may also extract a VIN from the RDR and determine a set of vehicle description data for the vehicle identified by the VIN. Data collection system 130 may then construct and transmit a reply message 330 to DMS 110 including the VIN and the vehicle description data.

Upon receiving the reply message, DMS 110 may retrieve detailed sales information associated with the VIN carried by the reply message. Finally, DMS 110 may construct and transmit a message to data collection system 130 containing the description data and detailed sales information, but not containing the VIN. Thus, through the described message transfer 300, the data collection system 130 may collect detailed sales information associated with a type of vehicle without concurrently collecting information that may identify the vehicle owner.

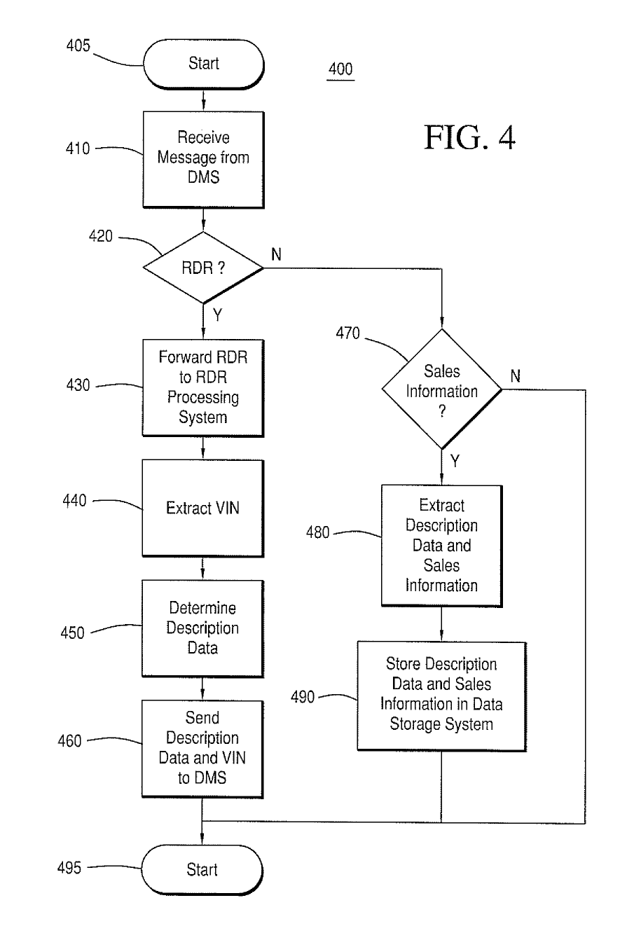

FIG. 4 is a flowchart of an exemplary method 400 for collecting data related to the sale of a vehicle. Method 400 may be performed by, for example, the components of data collection system 130 to appropriately handle a message received from DMS 110. Other suitable components for execution of method 400 will be apparent to those of skill in the art.

Method 400 may begin in step 405 and proceed to step 410 where data collection system 130 may receive a message from DMS 110. Data collection system 130 may then determine in step 420 whether the received message contains an RDR. If the message contains an RDR, method 400 may proceed to step 430 where data collection system 130 may forward the RDR to RDR processing system 140 for further processing. Data collection system 130 may then extract a VIN from the RDR and generate a set of description information for the vehicle identified by the VIN in steps 440 and 450, respectively, and according to the methods previously described. Method 400 may then proceed to step 460 where data collection system 130 may transmit the VIN and set of description data to the DMS 110. Method 400 may then end in step 495.

If, on the other hand, it is determined in step 420 that the received message does not contain an RDR, method 400 may proceed to step 470 where data collection system 130 may determine whether the message contains detailed sales information. If the message contains detailed sales information, data collection system 130 may extract this information along with a set of vehicle description data and store them in data storage system 150 in steps 480 and 490, respectively. Method 400 may then end at step 495. If the message is determined in step 470 not to contain detailed sales information, method 400 may simply end at step 495 and data collection system 130 may wait for another message from DMS 110. Alternatively, in embodiments wherein a data collection system 130 is further adapted to process message types other than those containing an RDR and/or detailed sales information, method 400 may proceed to additional steps (not shown) that further evaluate and process the contents of the received message.

Having described exemplary components and methods for the operation of exemplary network 100, an example of the operation of exemplary networks 100 will now be provided with reference to FIGS. 1-5.

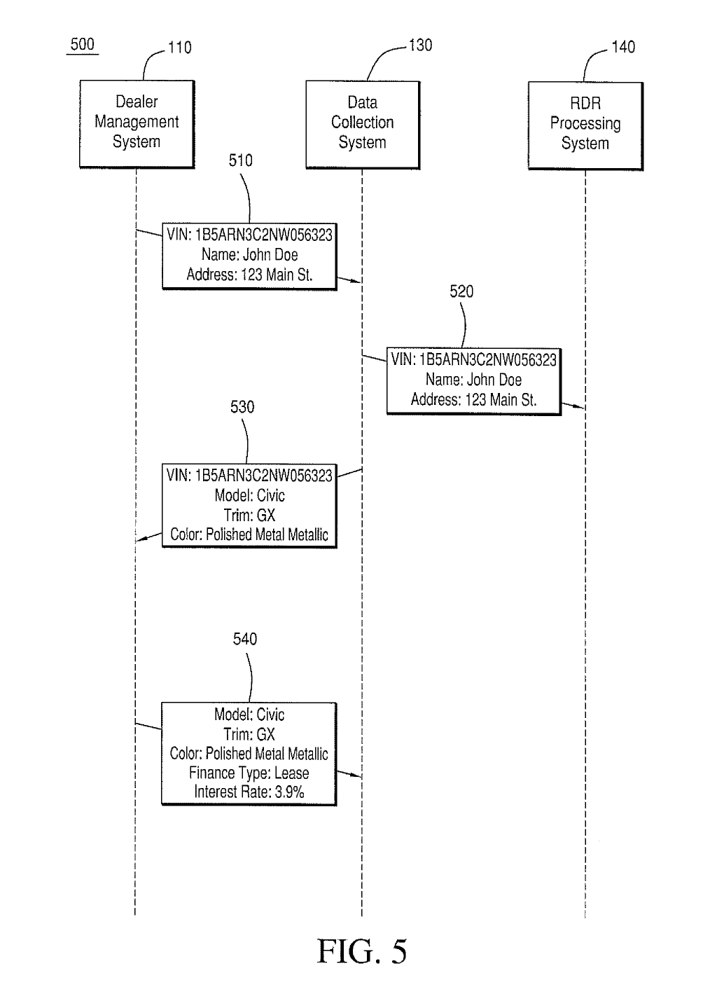

FIG. 5 is a schematic diagram of an exemplary message transfer 500 for collecting data related to the sale of a specific vehicle and not associated with the vehicle owner. Exemplary message transfer 500 will be described as a specific example of the system described above with respect to FIGS. 1-4.

In the simplified system represented by FIG. 5, a complete RDR may contain a VIN, the customer's name, and the customer's address. Further, a sufficient set of vehicle description data may include a model, trim, and color. Finally, the detailed sales information to be collected may include the financing method employed and interest rate obtained by the customer.

Message transfer 500 begins after the sale of the vehicle having the VIN “1B5ARN3C2NW056323” to a customer named John Doe who lives at 123 Main St. DMS 110 transmits an RDR 510 containing this information to data collection system 130. The message recognition module 220 of data collection system 130 determines that the received message contains an RDR and, accordingly, forwards the message to both message forwarding module 230 and VIN extraction module 250. Message forwarding module 230 simply forwards the RDR 520 to RDR processing system 140. VIN extraction module extracts the VIN “1B5ARN3C2NW056323” from the message and passes it to vehicle description module 260.

Vehicle description module 260 then decodes the VIN to determine that the vehicle is a Civic GX. Vehicle description module 260 further consults a database (not shown) to determine that the vehicle having VIN “1B5ARN3C2NW056323” was painted with Polished Metal Metallic paint. This description data along with the VIN is then passed to reply module 270 which constructs and transmits a reply message 530 to DMS 110.

Upon receipt of the reply message 530, DMS 110 consults its local records to determine that the vehicle with VIN “1B5ARN3C2NW056323” was leased at an interest rate of 3.9%. DMS 110 then transmits a sales information message 540 to data collection system 130 containing this sales information along with the received description information, but without the VIN. Upon receipt of the sales information message 540, message recognition module 220 determines that the message contains sales information. Message recognition module 220 then passes the message to data extraction module 280, which extracts the sales information and the set of vehicle description data from the message. Data extraction module 280 then transmits the extracted information to data storage system 150. Thus, data storage system 150 has been updated to reflect the fact that a Polished Metal Metallic Civic GX has been leased with an interest rate of 3.9%.

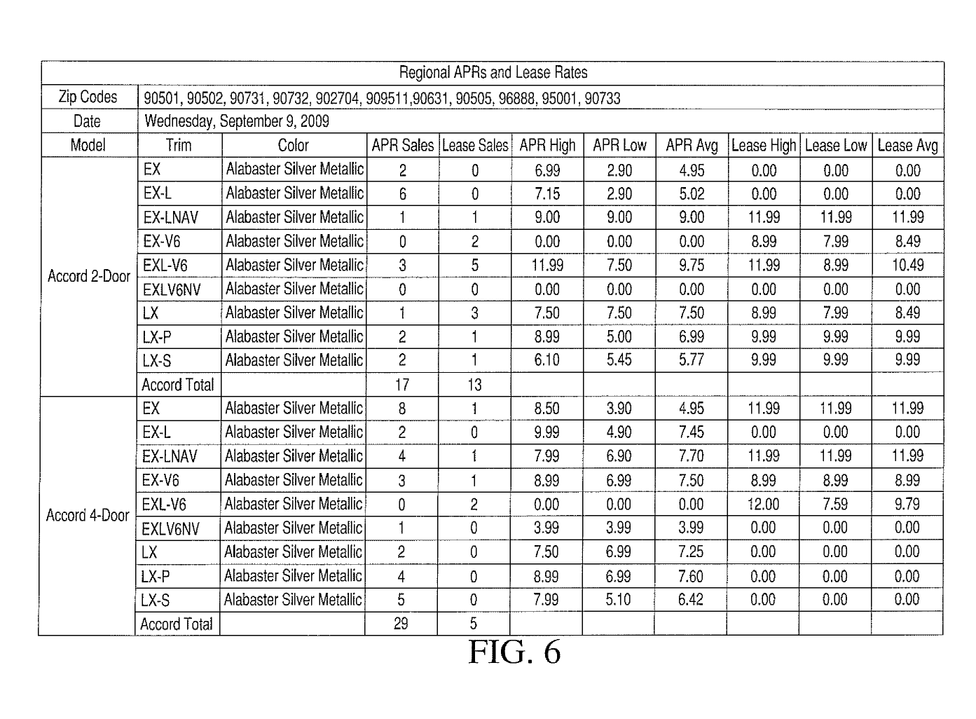

FIG. 6 is a schematic diagram of an exemplary report 600 generated using collected data. Exemplary report 600 may be generated, for example, by data collection system 130 or some other system (not shown) having access to data storage system 150. Exemplary report 600 is only one example of a report that may be generated using the data collected by data collection system 130. A person of skill in the art would recognize that many variations of exemplary report 600 may exist which convey further or different information and may be used in differing situations where appropriate.

Exemplary report 600 may be a summary of APR and lease rates for vehicles sold on Wednesday, Sep. 9, 2009, in the region encompassing zip codes 90501, 90502, 90731, 90732, 902704, 909511, 90631, 90505, 96888, 95001, and 90733. Exemplary report 600 may be further limited to displaying sales data for “Accord 2-Door” and “Accord 4-Door” models having an Alabaster Silver Metallic color and a trim of “EX”, “EX-L”, “EX-LNAV”, “EX-V6”, “EXL-V6”, “EXLV6NV”, “LX”, “LX-P” or “LX-S”. Exemplary report 600 may convey sales data for each combination of a model, a trim, and a color. Such sales data may include the number of APR sales, the number of leases, the highest APR, the lowest APR, the average APR, the highest lease rate, the lowest lease rate, and the average lease rate. Exemplary report 600 may be used by a manufacturer or other entity to gauge the relative performance of each combination of a model, a trim, and a color in the marketplace.

According to the foregoing, various exemplary embodiments provide for the collection of detailed sales data without concurrent disclosure of customer identifying information. Particularly, by receiving detailed sales information associated with a vehicle description provided to the DMS rather than a VIN, a manufacturer may collect sales information for every vehicle sold in real time, which might ensure compliance with privacy laws, regulations, or rules, such as the Gramm-Leach-Bliley Act. More specifically, gathering financing and leasing information for all vehicle transactions in real time may be accomplished without the concurrent disclosure of personal identifying information.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

Although the various exemplary embodiments have been described in detail with particular reference to certain exemplary aspects thereof, it should be understood that the invention is capable of other embodiments and its details are capable of modifications in various obvious respects. For example, the data collection system 200 of FIG. 2 may have additional, fewer, or different components. As another example, further deal or sales information may be sent, received, stored, and used for reporting, including a name of a dealer, a geographic location of a dealer, sales history of a customer (e.g., if a customer is a repeat or first time customer), a customer age range, a customer income range, other types of demographic information, and the like. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

Further, while the above description has been described with respect to systems and methods for sales of automobiles, the same may be applied to sales of other goods or services, which might also assist in the provision of detailed information about sales while maintaining privacy of consumer information. For example, the combination of the systems of FIG. 1 may be modified to allow for transferring of information related to other mobility products or parts of mobility products, including motorcycle vehicle sales, part sales, engine sales, vehicle service contracts, and the like. For example, a system of a financial institution may send an order number to a data collection system, where the order number includes part numbers. Following that example, the data collection system may decode a description of the parts from the part number and respond to the financial institution with the order number and part descriptions. In response to that communication, the financial institution may send to the data collection system parts descriptions along with sale information, such as demographic information of a consumer. The data collection system may use that data for reports about part sales and associated demographic information. The system may apply to other sales environments. As an example, for purposes of sale of appliances, a serial number of an appliance may be used instead of a VIN, the serial number may be sent to a data collection system, the data collection system may decode the serial number to a type of appliance and description of the appliance, the data collection system may send that information along with the serial number to a financial institution, and the financial institution may send the description of the appliance along with other sales data to the data collection system.

It should also be noted that, while FIGS. 1-5 are indicated as having a relationship where FIGS. 2-5 describe portions of FIG. 1, such a relationship need not exist. For example, the method of FIG. 4 may be implemented in a system other than the system including the network 100 of FIG. 1.

1. A machine-readable medium encoded with instructions for collecting data related to the sale of a product from a sales system at a data collection system, the machine readable medium comprising:
instructions for receiving, at the data collection system, a first message from the sales system, the first message including a product identifier for the product;
instructions for determining a set of description data describing the product using the product identifier;
instructions for constructing a second message including the product identifier and the set of description data;
instructions for transmitting the second message to the sales system;
instructions for receiving, at the data collection system, a third message from the sales system, the third message including the set of description data and a set of sale information but not including the product identifier; and
instructions for transmitting the set of description data and the set of sale information for storage in a database.

2. The machine-readable medium of claim 1, wherein the first message is a Retail Delivery Registration (RDR) and the machine-readable medium further comprises instructions for forwarding the RDR to an RDR processing system.

3. The machine-readable medium of claim 1, wherein the product is a vehicle and the set of description data includes an indication of a model, a trim, and a color of the vehicle.

4. The machine-readable medium of claim 1, wherein the instructions for determining a set of description data describing the product using the product identifier comprise decoding the product identifier to obtain at least a portion of the set of description data.

5. The machine-readable medium of claim 1, wherein the instructions for determining a set of description data describing the product using the product identifier comprise instructions for retrieving a record associated with the product identifier and containing at least a portion of the set of description data.

6. The machine-readable medium of claim 1, wherein the set of sale information includes information related to at least one of: financing and leasing of the product.

7. The machine-readable medium of claim 1, wherein the database is a local database of the data collection system and the instructions for transmitting the set of description data and the set of sale information for storage in a database comprise instructions for storing the set of description data and the set of sale information in the local database.

8. A Data Collection System for collecting data related to the sale of a vehicle from a Dealer Management System (DMS), the data collection system comprising:
an Interface that receives messages from and transmits messages to the DMS;
a Vehicle Identification Number (VIN) Extraction Module that receives a Retail Delivery Request (RDR) and extracts a VIN from the RDR;
a Vehicle Description Module that determines a set of description data associated with the VIN extracted by the VIN Extraction Module;
a Reply Module that constructs and transmits a reply message to the DMS via the Interface, the reply message including the VIN extracted by the VIN Extraction Module and the set of description data determined by the Vehicle Description Module;
a Data Extraction Module that receives a sales data message, extracts a set of vehicle description data and data related to a sale of a vehicle from the sales data message, and transmits the set of vehicle description data and the data related to the sale to a Data Storage System; and
a Message Recognition Module that:
determines whether a message received from the DMS via the Interface is an RDR or a sales data message,
when the received message is an RDR, forwards the message the VIN extraction module, and
when the received message is a sales data message, forwards the message to the Data Extraction Module.

9. The Data Collection System of claim 8, further comprising:
a Message Forwarding Module that receives an RDR from the Message Recognition Module and transmits the RDR to an RDR processing system.

10. The Data Collection System of claim 8, wherein the set of description data includes a model of the vehicle.

11. The Data Collection System of claim 9, wherein the set of description data further includes a trim and a color of the vehicle.

12. The Data Collection System of claim 8, wherein the Data Storage System is a component of the Data Collection System.

13. The Data Collection System of claim 8, wherein the data related to the sale of the vehicle includes at least one of: financing information and leasing information.

14. A machine-readable medium encoded with instructions for collecting data related to the sale of a vehicle from a Dealer Management System (DMS) at a data collection system, the machine-readable medium comprising:
instructions for receiving, at the data collection system, a first message from the DMS, the first message including a Vehicle Identification Number (VIN) for the vehicle;
instructions for determining a set of description data describing the vehicle using the VIN;
instructions for constructing a second message including the VIN and the set of description data;
instructions for transmitting the second message to the DMS;
instructions for receiving, at the data collection system, a third message from the DMS, the third message including the set of description data and a set of sale information but not including the VIN; and
instructions for transmitting the set of description data and the set of sale information for storage in a database.

15. The machine-readable medium of claim 14, wherein the first message is a Retail Delivery Registration (RDR) and the machine-readable medium further comprises instructions for forwarding the RDR to an RDR processing system.

16. The machine-readable medium of claim 14, wherein the set of description data includes an indication of a model, a trim, and a color of the vehicle.

17. The machine-readable medium of claim 14, wherein the instructions for determining a set of description data describing the vehicle using the VIN comprise decoding the VIN to obtain at least a portion of the set of description data.

18. The machine-readable medium of claim 14, wherein the instructions for determining a set of description data describing the vehicle using the VIN comprise instructions for retrieving a record associated with the VIN and containing at least a portion of the set of description data.

19. The machine-readable medium of claim 14, wherein the set of sale information includes information related to at least one of: financing and leasing of the vehicle.

20. The machine-readable medium of claim 14, wherein the database is a local database of the data collection system and the instructions for transmitting the set of description data and the set of sale information for storage in a database comprise instructions for storing the set of description data and the set of sale information in the local database.

21. A system for collecting data related to a sale of a vehicle, comprising:
a Dealer Management System (DMS);
a Data Collection System;
a Retail Delivery Registration(RDR) Processing System; and
a Data Storage System, wherein:
the DMS:
transmits an RDR including a Vehicle Identification Number (VIN) to a Data Collection System after the sale of the vehicle,
receives a reply message from the Data Collection System,
extracts the VIN and a set of vehicle description data from the reply message,
retrieves a set of data related to the sale of the vehicle from at least one local record associated with the VIN,
constructs a sales data message including the set of vehicle description data and the data related to the sale of the vehicle, and
transmits the sales data message to the Data Collection System,
the Data Collection System:
receives the RDR from the DMS,
forwards the RDR to an RDR Processing System,
extracts the VIN from the RDR,
determines the set of vehicle description data associated with the VIN,
constructs a reply message including the VIN and the set of vehicle description data,
transmits the reply message to the DMS,
receives a sales data message from the DMS, and
transmits the set of vehicle description data and the data related to the sale of the vehicle to a Data Storage System,
the RDR Processing System:
receives the RDR from the Data Collection System, and
updates a database to show that the vehicle has been sold and that a warranty is active, and
the Data Storage System
receives the set of vehicle description data and the data related to the sale of the vehicle from the Data Collection System, and
stores a new record containing the set of vehicle description data and the data related to the sale of the vehicle.
